(19) United States
(12) Patent Application Publication
(10) Pub. No.: US 2007/0234805 A1
(43) Pub. Date: Oct. 11, 2007

(54) Remote, early-time acoustic impact Doppler inspection

(75) Inventor: David C. MacEnany, Arlington, VA (US)

Correspondence Address: BINGHAM MCCUTCHEN LLP, 2020 K Street, N.W., Intellectual Property Department, WASHINGTON, DC, 20006, US

(73) Assignee: BAE SYSTEMS Information and Electronic Systems Integration Inc.

(21) Appl. No.: 11/366,451

(22) Filed: Mar. 3, 2006

(51) Int. Cl. G01H 17/00

(52) U.S. Cl. 73/570

(57) ABSTRACT

A method for nondestructive analysis is disclosed. The method includes measuring a distance between an acoustic source and each of the points to be analyzed (pixels) on the surface of an object. An optimization is then defined using the distance measurements. Thereafter, the object at each target pixel is acoustically bombarded, and the surface response at each pixel is recorded and measured. Optionally, the surface response measurements may be processed to account for extraneous information. The calculated optimization may then be used to generate the early-time line-up of the recorded measurements, and the processed information may be analyzed using the generated early-time line-up to image the internal structure object.

### TECHNICAL FIELD

The presently disclosed embodiments relate to an improvement on current methods of non-destructive structural analysis that use acoustic impact Doppler techniques.

### BACKGROUND

Nondestructive inspection techniques have been employed for many years in the field of structural analysis. The theory itself is simple: an object is bombarded by waves (in many cases, sound waves) such that the incident waves do not fundamentally alter the structure of the object. The waves excite various elements of the objects, which are then analyzed. By processing the characteristics of the excitations of the object, information may be obtained regarding the internal structure of the object, and the object itself may be accurately imaged.

A primary utility of this technique is its ability to examine the structural integrity of an object (for example, an airplane wing) without disassembling the object. Defects such as stress fractures, voids, manufacturing defects, and the like all affect the excitation of the object and thus may be imaged during the processing of the received signals. Comparing a known control image with one generated by the nondestructive analysis and evaluating for said stress fractures, voids, or manufacturing defects is a viable method for determining the quality of a given object. While it may be necessary under certain circumstances to expend the time and resources to disassemble the object and examine it piece by piece, accurate nondestructive testing can greatly streamline the process of structural analysis.

Remote Acoustic Impact Doppler (RAID) inspection, a state-of-the-art nondestructive analysis technique, operates by bombarding an object with air-coupled pressure waves that impact and excite the object. The RAID method was initially described in 1997, U.S. Pat. No. 5,616,865 (Webster). Local differences in the substructure of the object deliver local differences in the measurable surface response, the latter as measured by a laser velocimeter. The surface response information is collected, processed, and combined to generate an image of the interior of the object, revealing anomalies in the substructure. Thus, a primary requirement for this method is the generation of high-quality imaging by the acoustic bombardment. The production of such a high quality image is strongly dependent upon the precise positioning of the sources and detectors, as well the minimization of external noise. It is in this step that the disadvantages of the conventional techniques become clear.

The current RAID method uses a full spectral analysis of the long-term velocity history obtained at each surface location (“pixel”). That is, the readings from each surface location are collected from the full time record of the inspection and analyzed accordingly. This type of detection scheme is a primary disadvantage with the RAID technique. Employing the long-term velocity histories of each surface location provides no concept of a surface location's reaction in the time immediately following the initial impact, the so-called initial line-up information. That is, examining the full spectral history of each pixel does not provide a technique for discerning when the background noise ends and some meaningful signal begins. Good initial line-up is necessary for proper interpretation of the received signals.

Therefore, data collected using conventional RAID techniques might involve various artifacts from microphonics or late-time acoustic reflections from rooms in which the measurements were conducted, involving features having little to do with objects of interest. Similarly, reflections due to acoustic impacts that occur inside the object may add coherently or incoherently and produce results that do not consistently indicate the true nature of the structure. Anisotropies within the object (wherein different elements of the object have different structural characteristics, for example, density, material, etc.) can also generate the anomalous spectral detail that complicates the underlying structure of the image. Therefore, there exists a need for a technique that mitigates the factors that may complicate the imaging of the object.

The presently disclosed embodiments relate to a method that can significantly improve the image quality in remote acoustic impact Doppler inspection. The primary disadvantage of conventional RAID techniques arise from the fact that over sufficient periods of time, in a multidimensional space, energy from multiple sources mix. Because RAID depends upon its very accurate local response to acoustic impacts, any sort of global energetic response can negatively affect the accuracy of the result.

### SUMMARY

The presently disclosed embodiments refer to a method that focuses the analysis of the impacts on the response of the object in the brief span of time following the acoustic impact (“early time”). The method overcomes the limitations of conventional RAID evaluation by controlling the initial acoustic impact and limiting the length of time each location is subjected to spectral analysis to the early time. In this way, the problem of energy mixing is traversed by limiting the time scale of the analysis.

The method comprises the following steps. First, the distance between the acoustic source and each point on the surface of the object must be estimated. This is necessary for the proper interpretation of the excitation of the object. The distance estimation exploits the fact that the extremely early-time response (i.e., in the span immediately following the impact) has an essentially fixed form, excepting amplitude. This form is nearly functionally independent of location on the object, as well as the material composition at a given location.

Thus, the qualitative form of this response may be estimated in advance and used to define an optimization (for example, a least squares optimization) for the initial time, t₀* (r,c), of the early time response at the (r,c)th pixel, for every pixel location, wherein r and c are coordinates on the two dimensional surface of the object. The optimization may be repeated to arrive at the best estimation for t₀* at each location, allowing for good early-time line-up of the signals received from the object.

Second, the object is acoustically impacted by a pressure wave, and the surface response of said object is measured. The surface measurements are then processed to accommodate for various anomalies that may negatively impact the quality of the measurements. These anomalies may include such features as background noise, background pressure, and the like.

Using the early-time line-up information calculated in the first step, the early-time response is subjected to initial processing, including lining up the signals according to time, spatial distribution, and the like. The full early-time response may then be taken as a small, fixed number of cycles or zero-sum section after the starting time estimate for each pixel. The end result is an optimal segment with a definite initial time that spans and defines the early-time response for each pixel. Additionally, the process may be repeated and a number of such segments may be averaged. Each such segment, or average segment, is then used to describe each pixel to be evaluated.

Once the measurement is sufficiently processed, it is analyzed for indications of structural anomalies in the object, such as voids, unintended heterogeneities, and manufacturing errors. The parsed data is used to estimate the size and location of the discovered anomalies, which are then classified according to type.

### BRIEF DESCRIPTION OF THE DRAWINGS

The above described features and advantages of the present invention will be more fully appreciated with reference to the detailed description and figures, in which:

FIG. 1 depicts an embodiment of the preparations required before the object is impacted.

FIG. 2 depicts an embodiment of the initial processing that may be performed upon each pixel.

FIG. 3 depicts an embodiment of the follow-up processing that serves to refine and classify the information gathered from each pixel.

### DETAILED DESCRIPTION

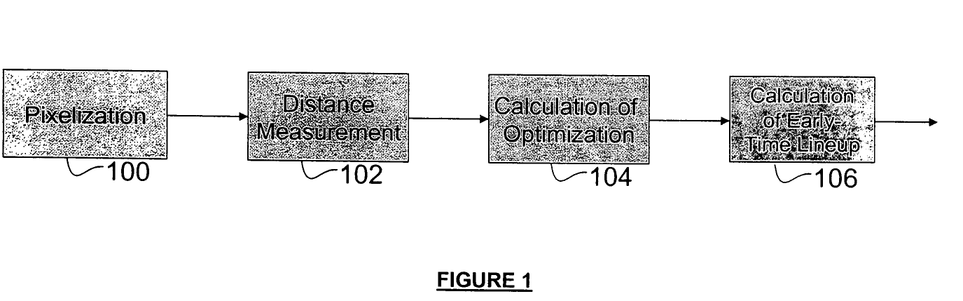

FIG. 1 depicts an embodiment of the initial stages of the method, during which the necessary preparations and calculations are accomplished. First, the surface of the object is divided, specifying the points at which the acoustic impacts will be targeted 100. These points are referred to as pixels, and the process is referred to as pixelization. In step 102, the distance between the source and each pixel is accurately determined. The calculation of an optimal observational span in step 104 for each pixel exploits the fact that the form (but not the amplitude) of the extremely-early-time response to an acoustic impact is functionally independent of location on the object, as well as the material composition of the object at a specific pixel location. Using the measurements collected in step 102, as well as the aforementioned similarity of the form of the response, an optimal observational span is calculated for each pixel. This is the time immediately following acoustic impact, when the signal from the surface response is least affected by anomalous external information. In step 106, these optimal observational spans are collected and ordered such that the early-time lineup is calculated for each pixel on the object.

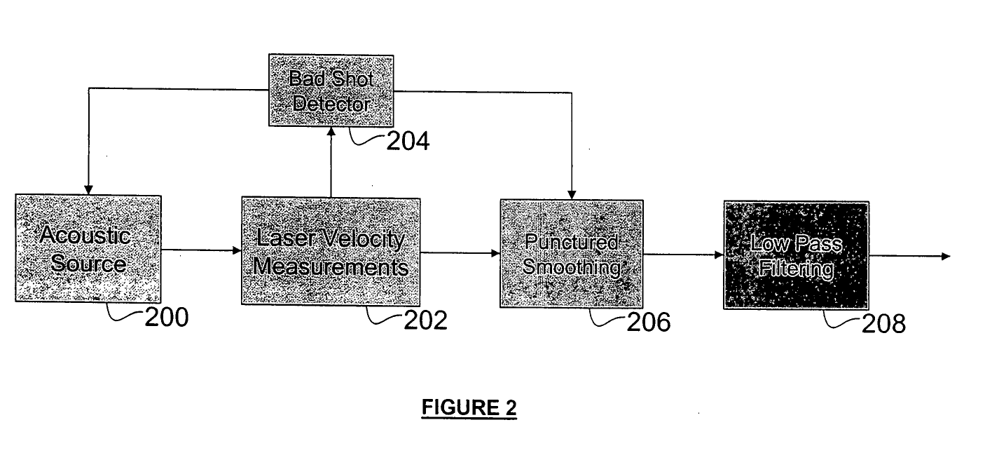

Once these calculations are accomplished, the acoustic source 200, as shown in FIG. 2, generates an air-coupled pressure wave with a smoothly varying spectral content that impacts the object. The surface response is measured by a laser velocimeter 202, which also serves as a “bad shot” detector 204, determining if the pressure wave impacted the target properly. If a “bad shot” is detected, wherein the pressure wave misses the intended target, the acoustic source 200 is instructed to emit another pressure wave.

Following a successful acoustic impact at a desired location, the shot velocity signal received by the laser velocimeter is sent through filters to smooth out meaningless anomalies. In step 206, a punctured smoothing filter is applied, which is a nonlinear processing filter that smoothes out two-dimensional spikes in the data. In step 208 a simple low-pass filter is applied to filter some of the background noise inherent in the system.

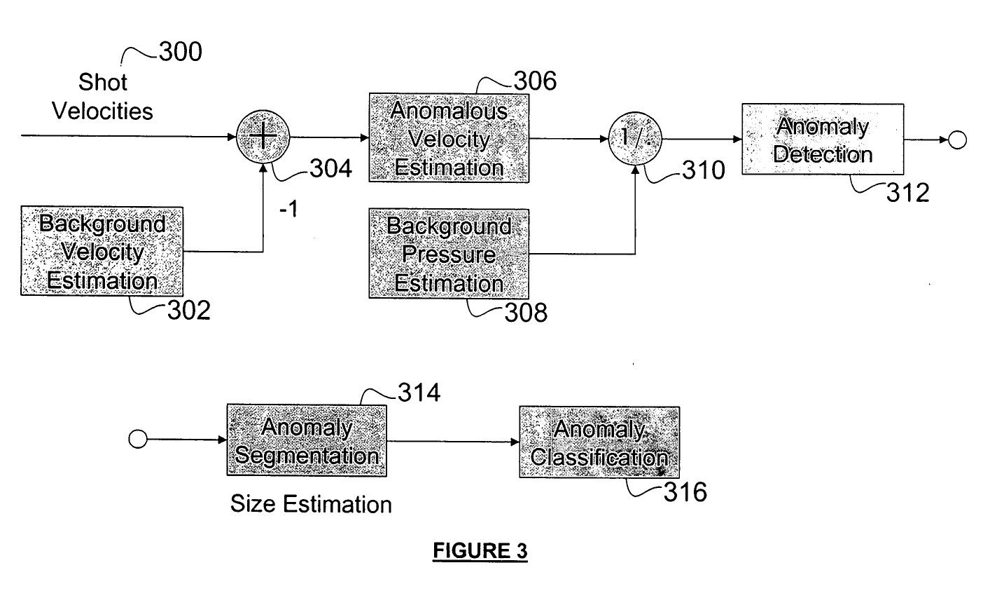

FIG. 3 depicts the more advanced processing steps performed upon the signal following the determination of shot velocities 300. First, any background vibrations now present in the object are estimated as velocities 302 analogous to the velocities induced by the acoustic impact. These estimated background velocities are subtracted from the received shot velocities 304. The velocity readings have now been sufficiently processed to allow for the estimation of probable meaningful anomalous velocities, i.e. velocities that refer to some flaw or feature within the object. From this new data set, anomalous shot velocities are estimated in step 306.

In step 308, the localized background pressures are estimated at each pixel. These results are used in step 310 to normalize the amplitudes of the recorded anomalous shot velocities and to allow for accurate imaging of the interior. Finally, in step 312, this information is collected and shot velocities indicating meaningful anomalies are culled from the data set. The anomalies are divided according to physical location and segmented into pieces for analysis in step 314, resulting in an estimation of the sizes of the defects or flaws that are represented by the determined anomalies. Finally, the characteristics of the interpreted shot velocity anomalies are analyzed in step 316 to classify the anomalies, for example, in terms of the type of flaw or defect determined.

While particular embodiments have been shown and described, changes may be made to those embodiments without departing from the spirit and scope of the present invention.

What is claimed is:

1. A method for nondestructive analysis comprising:
measuring a distance between an acoustic source and each of the points to be analyzed (pixels) on the surface of the object;
defining an optimization using the distance measurements;
acoustically bombarding the object at each target pixel;
recording and measuring the object's surface response at each pixel;
processing the surface response measurements to account for extraneous information;
using the calculated optimization to generate the early-time line-up of the recorded measurements; and
analyzing this processed information using the generated early-time line-up to image the internal structure object.

2. The method of claim 1, wherein each pixel is acoustically bombarded a plurality of times and the results are averaged.

3. The method of claim 1, wherein the processing of the surface response comprises multiple processing steps.

4. The method of claim 3, wherein the processing is grouped into two segments, initial and follow-on processing, wherein
the initial processing comprises bad shot detection, puncture filtering, and low-pass filtering of the received signals; and
the follow-on processing comprises subtracting estimated background velocities;
estimating anomalous received shot velocities;
normalizing the received shot velocities with respect to estimated background pressures;
detecting anomalies contained within this processed data;
segmenting these detected anomalies to localize them on the object; and
classifying the anomalies.

5. A method for nondestructive analysis comprising:
performing initial processing and calculations upon known quantities regarding an acoustic source and an object of interest in order to specify times of interest during the acoustic bombardment of the object;
acoustically bombarding the object at each target pixel;
recording and measuring the object's surface response;
processing the surface response measurements;
detecting anomalies within the processed measurements; and
classifying the anomalies.

6. The method of claim 5, wherein the initial processing and calculations comprise measuring the distance between the acoustic source and each of the points to be analyzed (pixels) on the surface of the object and defining the distance measurements using an optimization.

7. The method of claim 5, wherein the processing of the surface response measurements comprises:
detecting bad shots;
low-pass filtering of the received signals;
punctured smoothing of the received signals;
subtracting estimated background velocities;
estimating anomalous received shot velocities; and
normalizing the received shot velocities with respect to estimated background pressures.

8. The method of claim 5, wherein each pixel is acoustically bombarded a plurality of times and the results are averaged.
